(19) United States
(12) Patent Application Publication
(10) Pub. No.: US 2017/0076649 A1
(43) Pub. Date: Mar. 16, 2017

(54) DISPLAY PANEL DRIVING APPARATUS, METHOD OF DRIVING DISPLAY PANEL USING THE SAME AND DISPLAY APPARATUS HAVING THE SAME

(71) Applicant: SAMSUNG DISPLAY CO., LTD., YONGIN-SI (KR)

(72) Inventors: YUN-TAE KIM, SEOUL (KR); KWAN-WOO LEE, ASAN-SI (KR); SUNG-WOON IM, ASAN-SI (KR)

(21) Appl. No.: 15/000,720

(22) Filed: Jan. 19, 2016

(30) Foreign Application Priority Data
Sep. 10, 2015 (KR) 10-2015-0128397

(51) Int. Cl. G09G 3/20; G09G 3/36

(52) U.S. Cl. CPC G09G 3/2003; G09G 3/36; G09G 2320/0666

(57) ABSTRACT

A display panel driving apparatus includes a data driving circuit, a gate driving circuit and a common voltage outputting circuit. The data driving circuit is configured to output a data signal based on image data to a data line of a display panel. The gate driving circuit is configured to output a gate signal to a gate line of the display panel. The common voltage outputting circuit is configured to output a common voltage according to grayscale values of the image data and set the common voltage in varying grayscale value intervals according to a decrease of the grayscale values of the image data.

### CROSS-REFERENCE TO RELATED APPLICATIONS

This application claims priority under 35 U.S.C. §119 to Korean Patent Application No. 10-2015-0128397, filed on Sep. 10, 2015, the disclosure of which is hereby incorporated by reference in its entirety.

### TECHNICAL FIELD

Exemplary embodiments of the present inventive concept relate to a display panel driving apparatus, a method of driving a display panel using the display panel driving apparatus, and a display apparatus having the display panel driving apparatus. More particularly, exemplary embodiments of the present inventive concept relate to a display panel driving apparatus driving a display panel to which a common voltage is applied, a method of driving a display panel using the display panel driving apparatus, and a display apparatus having the display panel driving apparatus.

### DISCUSSION OF THE RELATED ART

A display apparatus includes a display panel and a display panel driving apparatus.

The display panel typically includes a lower substrate, an upper substrate and a liquid crystal layer. The lower substrate includes a first base substrate, a gate line, a data line, a thin film transistor and a pixel electrode. The upper substrate includes a second base substrate and a common electrode. The liquid crystal layer includes a liquid crystal. A pixel voltage is applied to the pixel electrode. A common voltage is applied to the common electrode. An arrangement of the liquid crystal is changed by an electric field generated due to the pixel voltage and the common voltage.

The display panel driving apparatus may include a gate driving circuit, a data driving circuit and a timing controlling circuit.

The gate driving circuit generates a gate signal and outputs the gate signal to the gate line of the display panel.

The data driving circuit receives image data from the timing controlling circuit, and outputs a data signal based on the image data to the data line of the display panel.

A flicker may be generated due to a kickback difference between a high grayscale in which a grayscale value of the image data is high and a low grayscale in which a grayscale value of the image data is low. Thus, display quality of the display apparatus may be degraded.

### SUMMARY

Exemplary embodiments of the present inventive concept provide a display panel driving apparatus capable of improving display quality of a display apparatus.

Exemplary embodiments of the present inventive concept also provide a method of driving a display panel using the above-mentioned display panel driving apparatus.

Exemplary embodiments of the present inventive concept also provide a display apparatus having the above-mentioned display panel driving apparatus.

According to an exemplary embodiment of the present inventive concept, a display panel driving apparatus includes a data driving circuit, a gate driving circuit and a common voltage outputting circuit. The data driving circuit is configured to output a data signal based on image data to a data line of a display panel. The gate driving circuit is configured to output a gate signal to a gate line of the display panel. The common voltage outputting circuit is configured to output a common voltage according to grayscale values of the image data and set the common voltage in varying grayscale value intervals according to a decrease of the grayscale values of the image data.

In an exemplary embodiment, the common voltage outputting circuit may include a common voltage setting circuit configured to set the common voltage corresponding to a representative grayscale value of the grayscale values, a grayscale value analyzing circuit configured to receive the image data and analyze the grayscale values of the image data to output grayscale value data, and a common voltage output circuit configured to receive the grayscale value data and output the common voltage according to the grayscale value data.

In an exemplary embodiment, the grayscale values of the image data may include a first grayscale section and a second grayscale section having a grayscale value greater than that of the first grayscale section. The common voltage setting circuit may set the common voltage in a first grayscale value interval in the first grayscale section, and may set the common voltage in a second grayscale value interval greater than the first grayscale value interval in the second grayscale section.

In an exemplary embodiment, the grayscale values of the image data may further include a third grayscale section having a grayscale value greater than that of the second grayscale section, and the common voltage setting circuit may set the common voltage in a third grayscale value interval greater than the second grayscale value interval in the third grayscale section.

In an exemplary embodiment, the common voltage setting circuit may set the common voltage in a first grayscale value interval in a first grayscale section having a first flicker difference and may set the common voltage in a second grayscale value interval greater than the first grayscale value interval in a second grayscale section having a second flicker difference less than that of the first grayscale section.

In an exemplary embodiment, the common voltage setting circuit may set the common voltage in a third grayscale value interval greater than the second grayscale value interval in a third grayscale section having a third flicker difference less than that of the second grayscale section.

In an exemplary embodiment, the grayscale values may include one to N grayscale values, in which N is a natural number equal to at least 64. The common voltage outputting circuit may first set a common voltage corresponding to an N/2 grayscale value and subsequently set common voltages corresponding to remaining grayscale values other than the N/2 grayscale value from among the one to N grayscale values.

In an exemplary embodiment, the common voltage outputting circuit may change the common voltage when the grayscale values are changed in an area at least equal to a reference area of a predefined area in the display panel.

In an exemplary embodiment, the predefined area may include a central area of the display panel.

In an exemplary embodiment, the common voltage outputting circuit may change the common voltage when the grayscale values are changed in an area at least equal to a reference area of the display panel.

In an exemplary embodiment, the common voltage outputting circuit may set the common voltage primarily according to an increase of the grayscale values.

In an exemplary embodiment, the display panel driving apparatus may further include a timing controlling circuit configured to output the image data to the common voltage outputting circuit.

According to an exemplary embodiment of the present inventive concept, a method of driving a display panel includes setting a common voltage in varying grayscale value intervals according to a decrease of grayscale values of image data, outputting the common voltage according to the grayscale values of the image data to the display panel, outputting a gate signal to a gate line of the display panel, and outputting a data signal based on the image data to a data line of the display panel.

In an exemplary embodiment, setting the common voltage may include setting the common voltage corresponding to a representative grayscale value of the grayscale values.

In an exemplary embodiment, outputting the common voltage according to the grayscale values of the image data to the display panel may include analyzing the grayscale values of the image data, outputting grayscale value data according to the grayscale values, receiving the grayscale value data, and outputting the common voltage according to the grayscale value data.

In an exemplary embodiment, the grayscale values of the image data may include a first grayscale section, a second grayscale section having a grayscale value greater than that of the first grayscale section, and a third grayscale section having a grayscale value greater than that of the second grayscale section. Setting the common voltage may include setting the common voltage in a first grayscale value interval in the first grayscale section, setting the common voltage in a second grayscale value interval greater than the first grayscale value interval in the second grayscale section, and setting the common voltage in a third grayscale value interval greater than the second grayscale value interval in the third grayscale section.

In an exemplary embodiment, setting the common voltage may include setting the common voltage in a first grayscale value interval in a first grayscale section having a first flicker difference, setting the common voltage in a second grayscale value interval greater than the first grayscale value interval in a second grayscale section having a second flicker difference less than that of the first grayscale section, and setting the common voltage in a third grayscale value interval greater than the second grayscale value interval in a third grayscale section having a third flicker difference less than that of the second grayscale section.

In an exemplary embodiment, outputting the common voltage according to the grayscale values of the image data to the display panel may include changing the common voltage when the grayscale values are changed in an area at least equal to a reference area of a predefined area in the display panel.

In an exemplary embodiment, the predefined area may include a central area of the display panel.

According to an exemplary embodiment of the present inventive concept, a display apparatus includes a display panel and a display panel driving apparatus. The display panel is configured to display an image, and includes a gate line and a data line. The display panel driving apparatus includes a data driving circuit configured to output a data signal based on image data of the image to the data line of the display panel, a gate driving circuit configured to output a gate signal to the gate line of the display panel, and a common voltage outputting circuit configured to output a common voltage according to grayscale values of the image data and set the common voltage in varying grayscale value intervals according to a decrease of the grayscale values of the image data.

According to an exemplary embodiment of the present inventive concept, a display panel driving apparatus includes a data driving circuit configured to output a data signal based on image data to a data line of a display panel, a gate driving circuit configured to output a gate signal to a gate line of the display panel, and a common voltage outputting circuit configured to output a common voltage according to grayscale values of the image data. The grayscale values are separated into a first grayscale section having a first grayscale value, a second grayscale section having a second grayscale value greater than the first grayscale value, and a third grayscale section having a third grayscale value greater than the second grayscale value. The common voltage outputting circuit is configured to set the common voltage in the first grayscale section using a first grayscale value interval, set the common voltage in the second grayscale section using a second grayscale value interval greater than the first grayscale value interval, and set the common voltage in the third grayscale section using a third grayscale value interval greater than the second grayscale value interval.

According to exemplary embodiments of the present inventive concept, a common voltage outputting circuit sets a common voltage in a small grayscale value interval according to a decrease of a grayscale value of image data. Therefore, the common voltage may be set adaptively to a flicker difference. In addition, the common voltage outputting circuit sets the common voltage corresponding to a representative grayscale value. Therefore, the common voltage may be effectively set. In addition, the common voltage outputting circuit sets the common voltages according to the grayscale values, respectively, and controls the common voltage according to the grayscale value. Therefore, a flicker of an image displayed on the display panel may be decreased. Thus, the display quality of the display apparatus may be improved.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a block diagram illustrating a display apparatus according to an exemplary embodiment of the present inventive concept.

FIG. 2 is a block diagram illustrating a common voltage outputting circuit of FIG. 1 according to an exemplary embodiment of the present inventive concept.

FIG. 3 is a concept diagram illustrating a method of setting common voltages according to grayscale values by the common voltage setting circuit of FIG. 2 according to an exemplary embodiment of the inventive concept.

FIG. 4 is a plan view illustrating a display panel of FIG. 1 according to an exemplary embodiment of the present inventive concept.

FIGS. 5A to 5C are flow charts illustrating a method of driving a display panel performed by a display panel driving apparatus of FIG. 1 according to an exemplary embodiment of the present inventive concept.

### DETAILED DESCRIPTION OF THE EXEMPLARY EMBODIMENTS

Exemplary embodiments of the present inventive concept will be described more fully hereinafter with reference to the accompanying drawings. In the drawings, the size and relative sizes of layers and regions may be exaggerated for clarity. Like reference numerals may refer to like elements throughout the accompanying drawings.

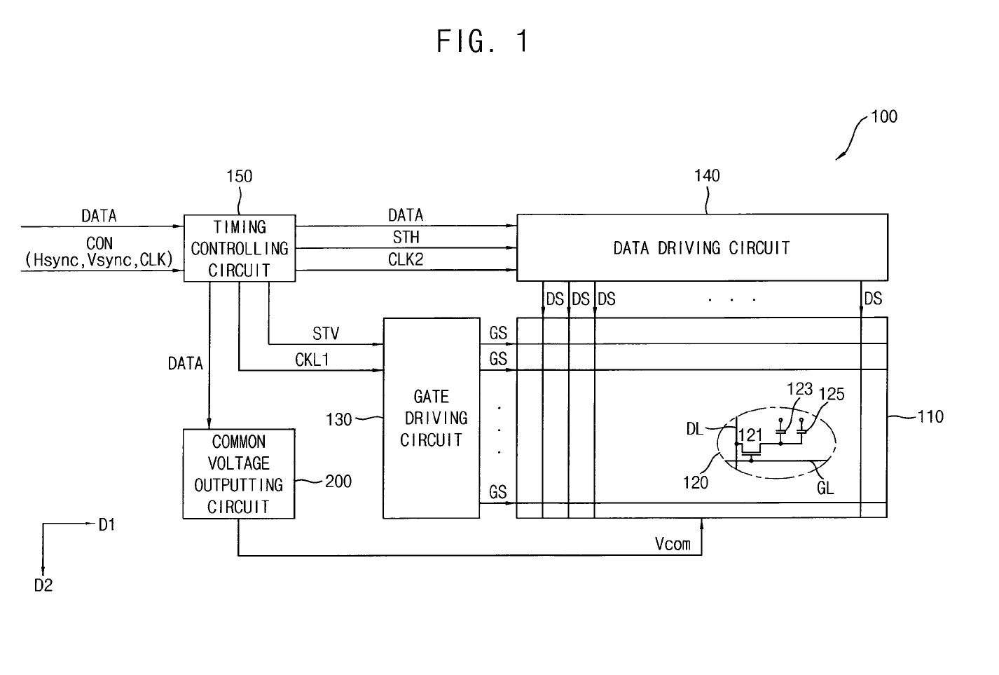

FIG. 1 is a block diagram illustrating a display apparatus according to an exemplary embodiment of the present inventive concept.

Referring to FIG. 1, the display apparatus 100 according to an exemplary embodiment includes a display panel 110, a gate driving circuit 130, a data driving circuit 140, a timing controlling circuit 150 and a common voltage outputting circuit 200. The gate driving circuit 130, the data driving circuit 140, the timing controlling circuit 150 and the common voltage outputting circuit 200 may be defined as a display panel driving apparatus which drives the display panel 110.

The display panel 110 receives a data signal DS based on image data DATA provided by the timing controlling circuit 150 to display an image. The display panel 110 includes gate lines GL, data lines DL and a plurality of pixels 120. The gate lines GL extend in a first direction D1 and are arranged in a second direction D2 substantially perpendicular to the first direction D1. The data lines DL extend in the second direction D2 and are arranged in the first direction D1. Each of the pixels 120 includes a thin film transistor 121 electrically connected to the gate line GL and the data line DL, a liquid crystal capacitor 123 and a storage capacitor 125 connected to the thin film transistor 121. Thus, the display panel 110 may be a liquid crystal display panel.

The gate driving circuit 130 generates a gate signal GS in response to a vertical start signal STV and a first clock signal CLK1 provided by the timing controlling circuit 150, and outputs the gate signal GS to the gate lines GL.

The data driving circuit 140 outputs the data signals DS to the data lines DL in response to a horizontal start signal STH and a second clock signal CLK2 provided by the timing controlling circuit 150.

The timing controlling circuit 150 receives the image data DATA and a control signal CON from an outside source (e.g., from a source external to the display apparatus 100). The control signal CON may include, for example, a horizontal synchronous signal Hsync, a vertical synchronous signal Vsync and a clock signal CLK. The timing controlling circuit 150 generates the horizontal start signal STH using the horizontal synchronous signal Hsync and outputs the horizontal start signal STH to the data driving circuit 140. In addition, the timing controlling circuit 150 generates the vertical start signal STV using the vertical synchronous signal Vsync and outputs the vertical start signal STV to the gate driving circuit 130. In addition, the timing controlling circuit 150 generates the first clock signal CLK1 and the second clock signal CLK2 using the clock signal CLK, outputs the first clock signal CLK1 to the gate driving circuit 130, and outputs the second clock signal CLK2 to the data driving circuit 140.

The common voltage outputting circuit 200 sets common voltages Vcom according to grayscale values. In addition, the common voltage outputting circuit 200 receives the image data DATA from the timing controlling circuit 150, and outputs the common voltage Vcom according to a grayscale value of the image data DATA.

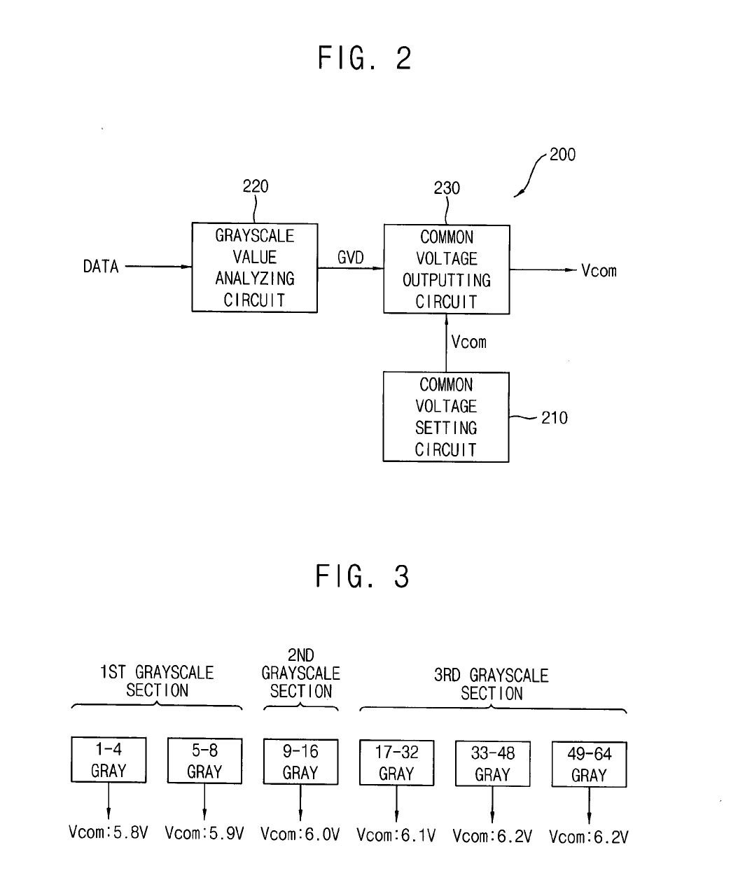

FIG. 2 is a block diagram illustrating the common voltage outputting circuit 200 of FIG. 1 according to an exemplary embodiment of the present inventive concept.

Referring to FIGS. 1 and 2, the common voltage outputting circuit 200 includes a common voltage setting circuit 210, a grayscale value analyzing circuit 220 and a common voltage outputting circuit 230.

The common voltage setting circuit 210 sets the common voltage Vcom according to grayscale values, as described in further detail below.

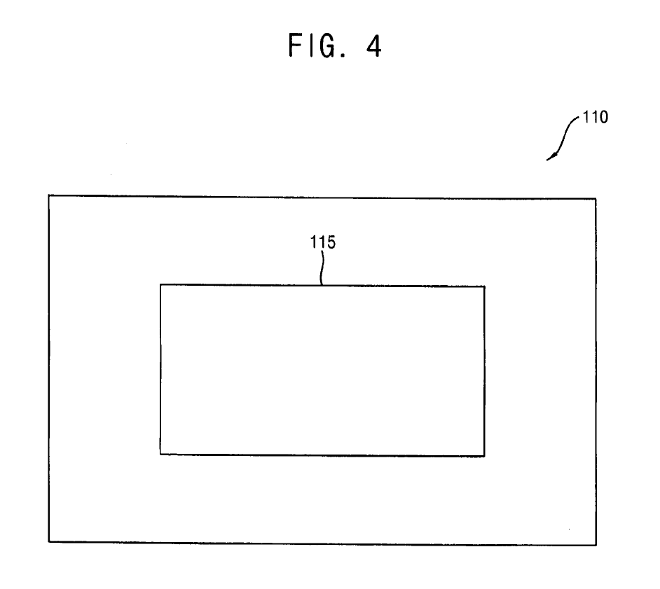

FIG. 3 is a concept diagram illustrating a method of setting the common voltages Vcom according to grayscale values by the common voltage setting circuit 210 of FIG. 2, according to an exemplary embodiment of the present inventive concept.

Referring to FIGS. 1 to 3, the grayscale values of the image data DATA include a first grayscale section having a comparatively low grayscale value, a second grayscale section having a grayscale value greater than that of the first grayscale section, and a third grayscale section having a grayscale value greater than that of the second grayscale section. For example, the image data DATA may have 1 to 64 grayscale values, as shown in FIG. 3. In this case, the grayscale values 1 to 8 may be part of the first grayscale section, grayscale values 9 to 16 may be part of the second grayscale section, and grayscale values 17 to 64 may be part of the third grayscale section.

According to exemplary embodiments, the common voltage setting circuit 210 may set the common voltage Vcom in varying grayscale value intervals according to a decrease of the grayscale value of the image data DATA. For example, as the grayscale value of the image data DATA decreases, the common voltage setting circuit may set the common voltage Vcom in smaller grayscale value intervals. In addition, the common voltage setting circuit 210 may set the common voltage Vcom corresponding to a representative grayscale value of the grayscale value.

For example, the common voltage setting circuit 210 may set the common voltage Vcom in a first grayscale value interval in the first grayscale section, may set the common voltage Vcom in a second grayscale value interval greater than the first grayscale value interval in the second grayscale section, and may set the common voltage Vcom in a third grayscale value interval greater than the second grayscale value interval in the third grayscale section.

For example, referring to FIG. 3, the common voltage setting circuit 210 may set the common voltage Vcom in intervals of 4 grayscale values in the first grayscale section, may set the common voltage Vcom in intervals of 8 grayscale values in the second grayscale section, and may set the common voltage Vcom in intervals of 16 grayscale values in the third grayscale section. Thus, the common voltage setting circuit 210 may set the common voltage Vcom in intervals of 4 grayscale values for the first to eighth grayscale values in the first grayscale section, may set the common voltage Vcom in intervals of 8 grayscale values for the ninth to sixteenth grayscale values in the second grayscale section, and may set the common voltage Vcom in intervals of 16 grayscale values for the seventeenth to sixty-fourth grayscale values in the third grayscale section.

In addition, the common voltage setting circuit 210 may set the common voltages Vcom according to the grayscale values in consideration of a flicker difference. For example, the common voltage setting circuit 210 may set the common voltage Vcom in the first grayscale value interval (e.g., an interval of 4 grayscale values) in the first grayscale section having a comparatively great flicker difference, may set the common voltage in the second grayscale value interval (e.g., an interval of 8 grayscale values) greater than the first grayscale value interval in the second grayscale section having a flicker difference less than that of the first grayscale section, and may set the common voltage Vcom in the third grayscale value interval (e.g., an interval of 16 grayscale values) greater than the second grayscale value interval in the third grayscale section having a flicker difference less than that of the second grayscale section.

The common voltage setting circuit 210 may set the value of the common voltage Vcom primarily according to an increase of the grayscale value of the image data DATA. For example, as shown in FIG. 3, the common voltage setting circuit 210 may set the common voltage Vcom to about 5.8 volts (V) for the grayscale value interval including grayscale values 1 to 4, may set the common voltage Vcom to about 5.9 volts (V) for the grayscale value interval including grayscale values 5 to 8, may set the common voltage Vcom to about 6.0 volts (V) for the grayscale value interval including grayscale values 9 to 16, may set the common voltage Vcom to about 6.1 volts (V) for the grayscale value interval including grayscale values 17 to 32, and may set the common voltage Vcom to about 6.2 volts (V) for each of the grayscale value intervals including grayscale values 33 to 48 and 49 to 64.

When the common voltage setting circuit 210 sets the common voltages Vcom according to the grayscale values, after the common voltage setting circuit 210 sets a common voltage corresponding to grayscale value N/2 from among 1 to N grayscale values (in which N is a natural number equal to at least 64), the common voltage setting circuit 210 may set common voltages corresponding to the remaining grayscale values other than the N/2 grayscale value from among the 1 to N grayscale values.

For example, after the common voltage setting circuit 210 sets the common voltage Vcom corresponding to grayscale value 32, the common voltage setting circuit 210 may set the common voltage Vcom corresponding to grayscale values 1 to 4, the common voltage Vcom corresponding to grayscale values 5 to 8, the common voltage Vcom corresponding to grayscale values 9 to 16, the common voltage Vcom corresponding to grayscale values 17 to 31, the common voltage Vcom corresponding to grayscale values 33 to 48, and the common voltage Vcom corresponding to grayscale values 49 to 64. It is to be understood that the order in which the common voltage setting circuit 210 sets the common voltage Vcom after setting the common voltage Vcom corresponding to grayscale value N/2 (e.g., grayscale value 32) is not limited to the order described herein. The common voltage Vcom corresponding to grayscale value 32, which is the common voltage corresponding to the N/2 grayscale value, may be defined as a reference common voltage. In addition, in an exemplary embodiment, the common voltages corresponding to the remaining grayscale values except for the N/2 grayscale value from among the 1 to N grayscale values may have a deviation up to about 0.5 volt (V) from the reference common voltage.

According to an exemplary embodiment of the present inventive concept, the grayscale values are separated into a first grayscale section having a first grayscale value, a second grayscale section having a second grayscale value greater than the first grayscale value, and a third grayscale section having a third grayscale value greater than the second grayscale value. The common voltage outputting circuit 200 is configured to set the common voltage Vcom in the first grayscale section using a first grayscale value interval, set the common voltage Vcom in the second grayscale section using a second grayscale value interval greater than the first grayscale value interval, and set the common voltage Vcom in the third grayscale section using a third grayscale value interval greater than the second grayscale value interval.

The grayscale value analyzing circuit 220 receives the image data DATA from the timing controlling circuit 150 and analyzes the grayscale values of the image data DATA to output grayscale value data GVD. Although the exemplary embodiment shown in FIGS. 1-3 shows the grayscale value analyzing circuit 220 receiving the image data DATA from the timing controlling circuit 150, exemplary embodiments of the present inventive concept are not limited thereto. For example, in an exemplary embodiment, the grayscale value analyzing circuit 220 may receive the image data DATA from a source outside of the display apparatus 100.

The common voltage outputting circuit 230 receives the grayscale value data GVD and outputs the common voltage Vcom according to the grayscale value data GVD, which is set by the common voltage setting circuit 210.

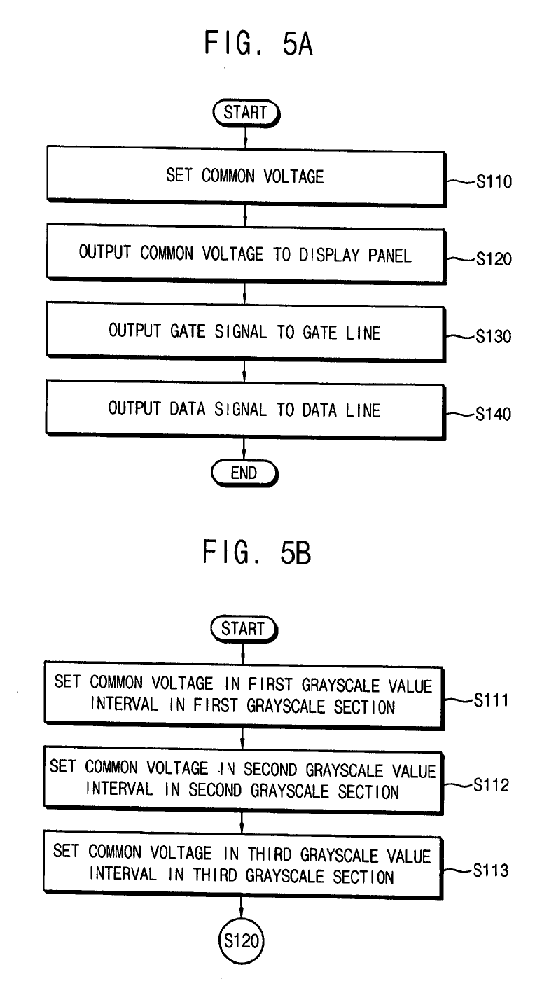

FIG. 4 is a plan view illustrating the display panel 110 of FIG. 1 according to an exemplary embodiment of the present inventive concept.

Referring to FIGS. 1 to 4, the display panel 110 may include a predefined area 115. The predefined area 115 may correspond a central area of the display panel 110, as shown in FIG. 4. Here, the central area may be an area in which a user of the display apparatus 100 concentrates most. However, the predefined area is not limited to the central area and the predefined area may be changed.

The grayscale value analyzing circuit 220 and the common voltage outputting circuit 230 of the common voltage outputting circuit 200 may change the common voltage Vcom when the grayscale value is changed in an area at least equal to a reference area of the predefined area 115. For example, the grayscale value analyzing circuit 220 and the common voltage outputting circuit 230 of the common voltage outputting circuit 200 may change the common voltage Vcom when the grayscale value is changed in an area at least equal to 50% of the predefined area 115. The predefined area 115 and the reference area may be changed.

Alternatively, the grayscale value analyzing circuit 220 and the common voltage outputting circuit 230 of the common voltage outputting circuit 200 may change the common voltage Vcom when the grayscale value is changed in a reference area of the display panel 110 without regard to the predefined area 115. For example, the grayscale value analyzing circuit 220 and the common voltage outputting circuit 230 of the common voltage outputting circuit 200 may change the common voltage Vcom when the grayscale value is changed in an area at least equal to 50% of the entire display panel 110.

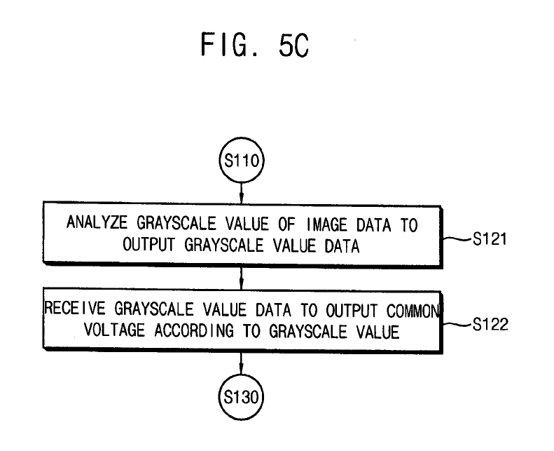

FIGS. 5A to 5C are flow charts illustrating a method of driving a display panel performed by the display panel driving apparatus of FIG. 1 according to an exemplary embodiment of the present inventive concept.

Referring to FIGS. 1 to 5C, the common voltage Vcom is set at operation S110. For example, the common voltage outputting circuit 200 sets the common voltages Vcom according to the grayscale values of the image data DATA, as described above. The common voltage setting circuit 210 of the common voltage outputting circuit 200 sets the common voltage Vcom in varying grayscale value intervals according to the decrease of the grayscale of the image data DATA. In addition, the common voltage setting circuit 210 sets the common voltage Vcom corresponding to the representative grayscale value of the grayscale value.

The grayscale values may include the first grayscale section having the comparatively low grayscale value, the second grayscale section having the grayscale value greater than that of the first grayscale section, and the third grayscale section having the grayscale value greater than that of the second grayscale section.

The common voltage setting circuit 210 may set the common voltage Vcom in the first grayscale value interval in the first grayscale section at operation S111. In addition, the common voltage setting circuit 210 may set the common voltage Vcom in the second grayscale value interval greater than the first grayscale value interval in the second grayscale section at operation S112. In addition, the common voltage setting circuit 210 may set the common voltage Vcom in the third grayscale value interval greater than the second grayscale value interval in the third grayscale section at operation S113. Here, the common voltage setting circuit 210 may set the common voltage Vcom corresponding to the representative grayscale value from among the grayscale values.

In addition, the common voltage setting circuit 210 may set the common voltages Vcom according to the grayscale values in consideration of the flicker difference, as described above. For example, the common voltage setting circuit 210 may set the common voltage Vcom in the first grayscale value interval in the first grayscale section having a comparatively great flicker difference, may set the common voltage in the second grayscale value interval greater than the first grayscale value interval in the second grayscale section having a flicker difference less than that of the first grayscale section, and may set the common voltage Vcom in the third grayscale value interval greater than the second grayscale value interval in the third grayscale section having a flicker difference less than that of the second grayscale section.

The common voltage setting circuit 210 may set the common voltage Vcom primarily according to the increase of the grayscale value. For example, as described above with reference to FIG. 3, in an exemplary embodiment, the common voltage setting circuit 210 may set the common voltage Vcom to about 5.8 volts (V) for the grayscale value interval including grayscale values 1 to 4, may set the common voltage Vcom to about 5.9 volts (V) for the grayscale value interval including grayscale values 5 to 8, may set the common voltage Vcom to about 6.0 volts (V) for the grayscale value interval including grayscale values 9 to 16, may set the common voltage Vcom to about 6.1 volts (V) for the grayscale value interval including grayscale values 17 to 32, and may set the common voltage Vcom to about 6.2 volts (V) for each of the grayscale value intervals including grayscale values 33 to 48 and 49 to 64.

When the common voltage setting circuit 210 sets the common voltages Vcom according to the grayscale values, after the common voltage setting circuit 210 sets the common corresponding to a grayscale value of N/2 from among 1 to N grayscale values (in which N is a natural number not less than 64), the common voltage setting circuit 210 may set common voltages corresponding to the remaining grayscale values other than the N/2 grayscale value from among the 1 to N grayscale values.

For example, after the common voltage setting circuit 210 sets the common voltage Vcom corresponding to grayscale value 32, the common voltage setting circuit 210 may set the common voltage Vcom corresponding to grayscale values 1 to 4, the common voltage Vcom corresponding to grayscale values 5 to 8, the common voltage Vcom corresponding to grayscale values 9 to 16, the common voltage Vcom corresponding to grayscale values 17 to 31, the common voltage Vcom corresponding to grayscale values 33 to 48, and the common voltage Vcom corresponding to grayscale values 49 to 64. It is to be understood that the order that the common voltage setting circuit 210 sets the common voltage Vcom after setting the common voltage to grayscale value N/2 (e.g., grayscale value 32) is not limited to the order described herein. The common voltage Vcom corresponding to grayscale value 32, which is the common voltage corresponding to the N/2 grayscale value, may be defined as the reference common voltage. In addition, in an exemplary embodiment, the common voltages corresponding to the remaining grayscale values except for the N/2 grayscale value from among the 1 to N grayscale values may have a deviation up to about 0.5 volt (V) from the reference common voltage.

The common voltage Vcom is output to the display panel 110 at operation S120. For example, the grayscale value analyzing circuit 220 of the common voltage outputting circuit 200 receives the image data DATA from the timing controlling circuit 150 and analyzes the grayscale value of the image data DATA to output the grayscale value data GVD at operation S121. The common voltage outputting circuit 230 of the common voltage outputting circuit 200 receives the grayscale value data GVD and outputs the common voltage Vcom according to the grayscale value, which is set by the common voltage setting circuit 210 at operation S122.

The grayscale value analyzing circuit 220 and the common voltage outputting circuit 230 of the common voltage outputting circuit 200 may change the common voltage Vcom when the grayscale value is changed in an area not less than the reference area of the predefined area 115, as described above. For example, the grayscale value analyzing circuit 220 and the common voltage outputting circuit 230 of the common voltage outputting circuit 200 may change the common voltage Vcom when the grayscale value is changed in an area not less than 50% of the predefined area 115. Here, the predefined area 115 may include the central area of the display panel 110.

The gate signals GS are output to the gate lines GL at operation S130. For example, the gate driving circuit 130 generates the gate signal GS in response to the vertical start signal STV and the first clock signal CLK1 provided by the timing controlling circuit 150, and outputs the gate signals GS to the gate lines GL.

The data signals DS are output to the data lines DL at operation S140. For example, the data driving circuit 140 outputs the data signals DS to the data lines DL in response to the horizontal start signal STH and the second clock signal CLK2 provided by the timing controlling circuit 150.

According to exemplary embodiments of the present inventive concept as described above, the common voltage outputting circuit 200 sets the common voltage Vcom in grayscale value intervals according to a decrease of the grayscale value of the image data DATA. The grayscale value intervals may start small and increase in size, as shown in FIG. 3. Therefore, the common voltage Vcom may be set adaptively to the flicker difference. In addition, the common voltage outputting circuit 200 may set the common voltage Vcom corresponding to a representative grayscale value. Therefore, the common voltage Vcom may be effectively set. In addition, the common voltage outputting circuit 200 may set the common voltages Vcom according to the grayscale values, respectively, and may control the common voltage Vcom according to the grayscale values. Therefore, a flicker of the image displayed on the display panel 110 may be decreased. Thus, the display quality of the display apparatus 100 may be improved.

According to exemplary embodiments of the present inventive concept, a display panel driving apparatus, a method of driving a display panel using the display panel driving apparatus, and a display apparatus having the display panel driving apparatus, a common voltage outputting circuit may set a common voltage in a small grayscale value interval according to a decrease of a grayscale value of image data. Therefore, the common voltage may be set adaptively to a flicker difference. In addition, the common voltage outputting circuit may set the common voltage corresponding to a representative grayscale value. Therefore, the common voltage may be effectively set. In addition, the common voltage outputting circuit may set the common voltages according to the grayscale values, respectively, and may control the common voltage according to the grayscale values. Therefore, a flicker of an image displayed on the display panel may be decreased. Thus, the display quality of the display apparatus may be improved.

While the present inventive concept has been particularly shown and described with reference to the exemplary embodiments thereof, it will be understood by those of ordinary skill in the art that various changes in form and detail may be made therein without departing from the spirit and scope of the present inventive concept as defined by the following claims.

What is claimed is:

1. A display panel driving apparatus, comprising:
a data driving circuit configured to output a data signal based on image data to a data line of a display panel;
a gate driving circuit configured to output a gate signal to a gate line of the display panel; and
a common voltage outputting circuit configured to output a common voltage according to grayscale values of the image data and set the common voltage in varying grayscale value intervals according to a decrease of the grayscale values of the image data.

2. The display panel driving apparatus of claim 1, wherein the common voltage outputting circuit comprises:
a common voltage setting circuit configured to set the common voltage corresponding to a representative grayscale value of the grayscale values;
a grayscale value analyzing circuit configured to receive the image data and analyze the grayscale values of the image data to output grayscale value data; and
a common voltage output circuit configured to receive the grayscale value data and output the common voltage according to the grayscale value data.

3. The display panel driving apparatus of claim 2,
wherein the grayscale values of the image data comprise a first grayscale section and a second grayscale section having a grayscale value greater than that of the first grayscale section,
wherein the common voltage setting circuit sets the common voltage in a first grayscale value interval in the first grayscale section, and sets the common voltage in a second grayscale value interval greater than the first grayscale value interval in the second grayscale section.

4. The display panel driving apparatus of claim 3,
wherein the grayscale values of the image data further comprise a third grayscale section having a grayscale value greater than that of the second grayscale section,
wherein the common voltage setting circuit sets the common voltage in a third grayscale value interval greater than the second grayscale value interval in the third grayscale section.

5. The display panel driving apparatus of claim 2, wherein the common voltage setting circuit sets the common voltage in a first grayscale value interval in a first grayscale section having a first flicker difference, and sets the common voltage in a second grayscale value interval greater than the first grayscale value interval in a second grayscale section having a second flicker difference less than the first flicker difference.

6. The display panel driving apparatus of claim 5, wherein the common voltage setting circuit sets the common voltage in a third grayscale value interval greater than the second grayscale value interval in a third grayscale section having a third flicker difference less than the second flicker difference.

7. The display panel driving apparatus of claim 1,
wherein the grayscale values comprise one to N grayscale values, wherein N is a natural number equal to at least 64,
wherein the common voltage outputting circuit first sets a common voltage corresponding to an N/2 grayscale value and subsequently sets common voltages corresponding to remaining grayscale values other than the N/2 grayscale value from among the one to N grayscale values.

8. The display panel driving apparatus of claim 1, wherein the common voltage outputting circuit changes the common voltage when the grayscale values are changed in an area at least equal to a reference area of a predefined area in the display panel.

9. The display panel driving apparatus of claim 8, wherein the predefined area comprises a central area of the display panel.

10. The display panel driving apparatus of claim 1, wherein the common voltage outputting circuit changes the common voltage when the grayscale values are changed in an area at least equal to a reference area of the display panel.

11. The display panel driving apparatus of claim 1, wherein the common voltage outputting circuit sets the common voltage primarily according to an increase of the grayscale values.

12. The display panel driving apparatus of claim 1, further comprising:
a timing controlling circuit configured to output the image data to the common voltage outputting circuit.

13. A method of driving a display panel, comprising:
setting a common voltage in varying grayscale value intervals according to a decrease of grayscale values of image data;
outputting the common voltage according to the grayscale values of the image data to the display panel;
outputting a gate signal to a gate line of the display panel; and
outputting a data signal based on the image data to a data line of the display panel.

14. The method of claim 13, wherein setting the common voltage comprises:
setting the common voltage corresponding to a representative grayscale value of the grayscale values.

15. The method of claim 13, wherein outputting the common voltage according to the grayscale values of the image data to the display panel comprises:
analyzing the grayscale values of the image data;
outputting grayscale value data according to the grayscale values;
receiving the grayscale value data; and
outputting the common voltage according to the grayscale value data.

16. The method of claim 13,
wherein the grayscale values of the image data comprise a first grayscale section, a second grayscale section having a grayscale value greater than that of the first grayscale section, and a third grayscale section having a grayscale value greater than that of the second grayscale section,
wherein setting the common voltage comprises:
setting the common voltage in a first grayscale value interval in the first grayscale section;
setting the common voltage in a second grayscale value interval greater than the first grayscale value interval in the second grayscale section; and
setting the common voltage in a third grayscale value interval greater than the second grayscale value interval in the third grayscale section.

17. The method of claim 13, wherein setting the common voltage comprises:
setting the common voltage in a first grayscale value interval in a first grayscale section having a first flicker difference;
setting the common voltage in a second grayscale value interval greater than the first grayscale value interval in a second grayscale section having a second flicker difference less than the first flicker difference; and
setting the common voltage in a third grayscale value interval greater than the second grayscale value interval in a third grayscale section having a flicker difference less than the second flicker difference.

18. The method of claim 13, wherein outputting the common voltage according to the grayscale values of the image data to the display panel comprises:
changing the common voltage when the grayscale values are changed in an area at least equal to a reference area of a predefined area in the display panel.

19. The method of claim 18, wherein the predefined area comprises a central area of the display panel.

20. A display apparatus, comprising:
a display panel configured to display an image and comprising a gate line and a data line; and
a display panel driving apparatus comprising:
a data driving circuit configured to output a data signal based on image data of the image to the data line of the display panel;
a gate driving circuit configured to output a gate signal to the gate line of the display panel; and
a common voltage outputting circuit configured to output a common voltage according to grayscale values of the image data and set the common voltage in varying grayscale value intervals according to a decrease of the grayscale values of the image data.
